(19) United States
(12) Patent Application Publication
(10) Pub. No.: US 2008/0140653 A1
(43) Pub. Date: Jun. 12, 2008

(54) Identifying Relationships Among Database Records

(76) Inventors: Douglas J. Matzke, Plano, TX (US); Robert C. Farrow, Dallas, TX (US); Chandler L. Burgess, Plano, TX (US)

Correspondence Address: BAKER BOTTS L.L.P., 2001 ROSS AVENUE, SUITE 600, DALLAS, TX, 75201-2980, US

(21) Appl. No.: 11/608,287

(22) Filed: Dec. 8, 2006

(51) Int. Cl. G06F 17/30

(52) U.S. Cl. 707/6

(57) ABSTRACT

Identifying relationships among records includes accessing a search record and corpus records. The search record comprises search tokens, where a search token is associated with a search token count. A corpus record comprises corpus tokens, where a corpus token is associated with a corpus token count. The following are repeated for each of at least a subset of the search tokens: identifying corpus tokens corresponding to the search token, and comparing the search token with the identified corpus tokens to yield comparisons. A relationship between the search record and at least one corpus record is determined in accordance with the comparisons.

### TECHNICAL FIELD

This invention relates generally to the field of information analysis and more specifically to identifying relationships among database records.

### BACKGROUND

Businesses and other organizations may process a large amount of documents. As particular examples, an engineering firm may produce hundreds of design specifications, a hospital may track millions of patient files, or a law firm may review hundreds of millions of documents and emails involved in lawsuit.

Computers may be used to analyze the documents. As an example, a computer may compare documents to identify relationships among the documents. Computers may perform the analysis more quickly than humans.

### SUMMARY OF THE DISCLOSURE

In accordance with the present invention, disadvantages and problems associated with previous techniques for identifying relationships among database records may be reduced or eliminated.

According to one embodiment of the present invention, identifying relationships among records includes receiving a search record comprising search tokens, where a search token is associated with a search token count. A corpus comprising corpus records is accessed. A corpus record comprises corpus tokens, where a corpus token is associated with a corpus token count. In one example, the search record is compared with the corpus records by comparing search token counts with corresponding corpus token counts. A relationship is determined in accordance with the comparisons.

Certain embodiments of the invention may provide one or more technical advantages. A technical advantage of one embodiment may be that tokens of the search record are compared with corresponding tokens of corpus records to identify relationships between the search record and the corpus records. Comparing by iterating over tokens may be more efficient than comparing by iterating over records.

A technical advantage of another embodiment may be that a token-based index may be used to describe the corpus records. The index may include token portions that identify corpus records that have a particular token count. The index may provide for more efficient retrieval of information about the corpus.

A technical advantage of another embodiment may be that a symmetrical differential scoring formula may be used to distinguish corpus records that are different from (either larger or smaller than) a search record from corpus records that are at least approximately equivalent to the search record.

A technical advantage of another embodiment may be that corpus tokens may be filtered according to information content. In one example, corpus tokens may be processed from higher information content tokens to lower information content tokens, which may allow for more efficient analysis. In another example, corpus tokens that fail to satisfy an information content threshold may be removed, which may allow for more efficient analysis.

A technical advantage of another embodiment may be that corpus records may represent documents. The corpus records may be compared to identify duplicate or near-duplicate documents.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a system for identifying relationships among database records;

FIG. 2 is an index that may be used to record the token counts of tokens of records;

FIG. 3 is a flowchart illustrating one embodiment of a method for identifying relationships among database records that may be used with the system of FIG. 1;

FIG. 4 is a flowchart illustrating another embodiment of a method for identifying relationships among database records that may be used with the system of FIG. 1; and

FIG. 5 is a flowchart illustrating one embodiment of a method for identifying relationships among documents that may be used with the system of FIG. 1.

### DETAILED DESCRIPTION OF THE DRAWINGS

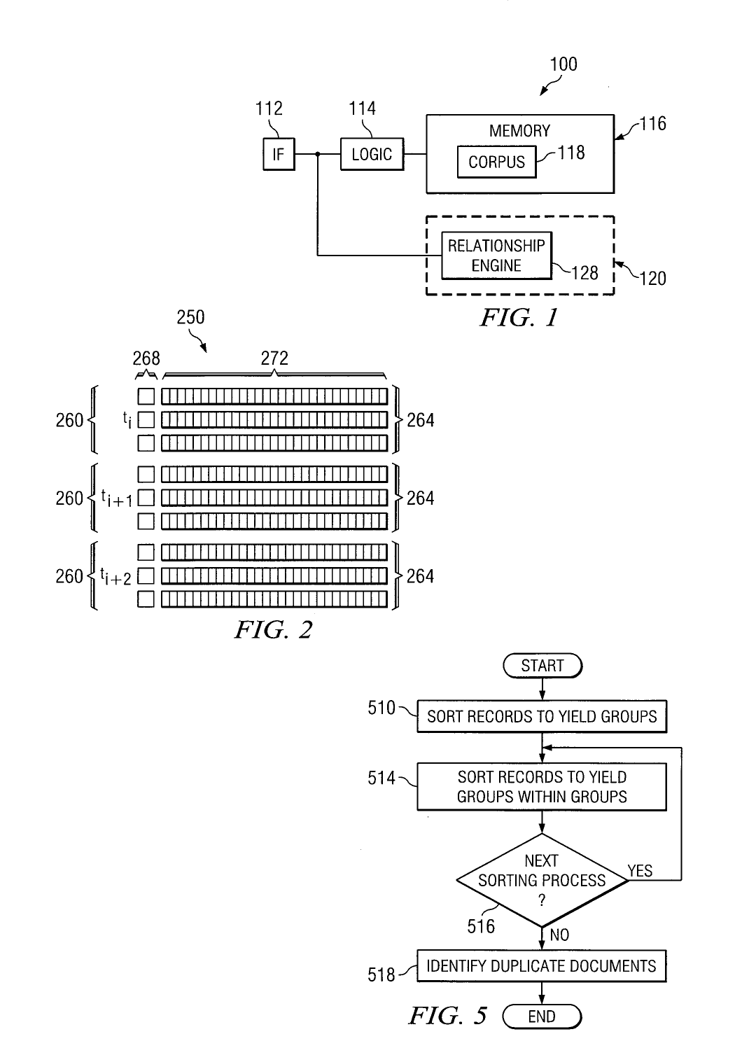

Embodiments of the present invention and its advantages are best understood by referring to FIGS. 1 through 5 of the drawings, like numerals being used for like and corresponding parts of the various drawings.

FIG. 1 is a block diagram illustrating one embodiment of a system 100 for identifying relationships among database records. According to the embodiment, system 100 compares tokens of records to identify relationships between the records. For example, system 100 compares tokens of a search record with corresponding tokens of corpus records to identify relationships between the search record and the corpus records.

Embodiments of system 10 may have any suitable feature. As an example, a token-based index may identify corpus records that have a given token count for a given token. As another example, a symmetrical differential scoring formula may be used to distinguish corpus records that are different from (either larger or smaller than) a search record from corpus records that are at least approximately equivalent to the search record. As another example, corpus tokens may be filtered according to information content. As another example, corpus records may represent documents and may be compared to identify duplicate or near-duplicate documents.

According to the illustrated embodiment, system 100 includes an interface 112, logic 114, a memory 116, and one or more engines 120 coupled as shown. System 100, however, may include any modules suitable for identifying relationships among database records.

Interface 112 may represent logic of a device operable to receive input for the device, send output from the device, perform suitable processing of the input or output or both, or any combination of the preceding, and may comprise one or more ports, conversion software, or both. Logic 114 may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

Memory 116 may refer to logic operable to store and facilitate retrieval of information, and may comprise a Random Access Memory (RAM), a Read Only Memory (ROM), a magnetic disk, a Compact Disk (CD), a Digital Video Disk (DVD), removable media storage, any other suitable data storage medium, or a combination of any of the preceding.

According to the illustrated embodiment, memory 116 stores a corpus 118. Corpus 118 may include corpus records that represent documents. According to the embodiment, “document” may refer to a recording of any suitable information. Examples of documents include a legal document, an electronic mail message, a memorandum, correspondence, a transcript, an accounting record, a product or design specification, a medical record, or other suitable recording of information. A document may have any suitable format, for example, a hard copy format such as a paper format, or a soft copy format, such as an electronic file format.

According to the embodiment, “record” may refer to a data structure that represents information. For example, a record may represent at least a portion of a document, such as a page of the document or the complete document. A record may have a record identifier that uniquely identifies the record.

A record rⱼ=(t₁ⱼ, . . . , tₙⱼ) may comprise one or more tokens tᵢ. According to the embodiment, “token” may refer to an entity that represents particular information of a document. For example, a token may represent a word, a set (such as an ordered or unordered set) of two or more words, a date, a number (such as a Bates number), a name, a symbol, a character, a group of characters, part or all of a signal or image, a feature of an image or signal, fields from a database or spreadsheet, and/or other particular information. A token may have a token identifier that uniquely identifies the token.

A token may represent discrete or continuous values. As an example, tokens may represent discrete values such as words. As another example, tokens may represent a range of continuous values. A particular token may represent a particular subset of the range, and the subsets represented by the tokens may cover the range.

A “token count” may indicate any suitable feature of a token of a record. According to one embodiment, an integer token count comprising an integer value may indicate the number of times a token appears in a record. For example, a token count for a token representing a word may indicate the number of times the word appears in the record. According to another embodiment, a binary token count comprising a binary value may indicate the presence or absence of a token in a record. For example, the token count may be less than two, either 0 to indicate the absence of the token or 1 to indicate the presence of the token.

Engines 120 may be used to identify relationships among database records. According to the illustrated embodiment, engines 120 include a relationship engine 128. Relationship engine 128 may identify relationships among records. For example, relationship engine 128 may compare a search token of a search record with a corresponding corpus token of the corpus records of corpus 118 to generate a relationship indicator for each corpus record. According to one embodiment, token counts may be compared. For example, the token count for a search token of the search record may be compared with the token count for the corresponding corpus token of a corpus record. In general, records with more similar token counts may be regarded as more similar that records with less similar token counts.

According to one embodiment, corpus records that are different from (either larger or smaller than) a search record may be distinguished from corpus records that are at least approximately equivalent to the search record. Record A may be larger than record B and record B may be smaller than record B if record B is a proper subset of record A. A first record may be a proper subset of a second record if the token counts of the second record include, but are not equivalent to, the token counts of the first record. A first record may be equivalent to a second record if the token counts of the first record are at least approximately equivalent or equivalent to the token counts of the second record.

A relationship indicator, such as a score, may indicate the relationship between records, such as between a search record and a corpus record. According to one embodiment, if the token counts of tokens tᵢ of the records are equivalent, then the score is a maximum value. If none of the token counts of records match, then the score is a minimum value. If the token counts of the records are similar, but not equivalent, then the score is in between the maximum value and the minimum value.

A score for a corpus record may indicate the relationship between the corpus record and the search record, and may be calculated in any suitable manner. According to one embodiment, a score for a record may be calculated from partial scores of tokens of the record. For example, a score SC(rⱼ) for record rⱼ may be calculated according to:

$$SC ( {r}_{j} ) = {\sum }_{i = 1}^{n} {P}_{i}$$

where i represents an index for token tᵢ, and Pᵢ represents the partial score for token tᵢ.

The partial score may be calculated in any suitable manner. According to one embodiment, partial score Pᵢ may be calculated according to:

Pᵢ=wᵢSᵢ

where Sᵢ represents a difference value for token tᵢ, and wᵢ represents a weight associated with token tᵢ. The difference value for token tᵢ may indicate the difference between the search token count and the corpus token count for token tᵢ.

The difference value may be calculated in any suitable manner. According to one embodiment, an asymmetrical subset scoring formula may be used to calculate the difference value. An asymmetrical subset scoring formula may refer to a formula that indicates whether a first record is a subset of a second record, but does not distinguish whether the first record is greater/smaller than or is equivalent to the second record. For example, the formula may yield a maximum score (for example, 100%) if the first record is a subset of (either a proper subset or equivalent to) the second record. An asymmetrical subset scoring formula may be used for comparing text.

In one example, an asymmetrical subset scoring formula for distance may be expressed as Sᵢ:

Sᵢ=C_{iSR}−Aᵢ

where

Aᵢ=c_{iSR}−min(c_{iSR}−c_{iCR})

and where c_{iSR} represents the token count of token tᵢ of the search record, c_{iCR} represents the token count of token tᵢ of the corpus record, and 0≦Sᵢ≦c_{iSR}.

According to one embodiment, a symmetrical differential scoring formula may be used to calculate the difference value. A symmetrical differential scoring formula may refer to a formula that differentiates corpus records that are different from (either larger or smaller than) a particular record from records that are at least approximately equivalent to the particular record. For example, the formula may yield a maximum value (for example, 100%) only if a record is at least approximately equivalent (for example, exactly equivalent) to the particular record.

In one example, a symmetrical differential scoring formula for distance may be expressed as Dᵢ:

Dᵢ=c_{iSR}−Mᵢ

where

Mᵢ=min(c_{iSR},|c_{iSR}−c_{iCR}|)

and where 0≦Dᵢ≦c_{iSR}. A symmetrical differential scoring formula may be used for comparing near-duplicates, marginalia, well logs, and/or other differential scoring applications.

According to one embodiment, final scores may be normalized and/or filtered. A final score may be normalized by dividing the final score by the search record score. A final score may be filtered according to a threshold value representing a minimum score that indicates the corpus record is worth investigating.

According to one embodiment, each token tᵢ may be associated with a weight wᵢ that may be used to calculate the score. According to the embodiment, weight wᵢ may indicate how the maximum score is degraded when token ti is not overlapping when making a match between a search record and a corpus record.

Any suitable weight wᵢ may be used. According to one embodiment, weight wᵢ may reflect the information content of a token tᵢ. The information content of a token tᵢ may indicate the ability of the token tᵢ to distinguish among records. In one example, a token that appears in more records may have less information content than a token that appears in fewer records. For example, uncommon words, such as technical terms, may be better at distinguishing corpus records than common words such as “the” and “and”.

The information content may be calculated in any suitable manner. As an example, weight wᵢ may be inversely proportional to the probability that token tᵢ appears in the corpus records of the corpus. In the example, weight wᵢ may be expressed as:

wᵢ=−log₁₀(Tᵢ)+log₁₀(A)

where Tᵢ represents the token count of token tᵢ for all the corpus records of the corpus, and A represents the token count of all tokens for all the corpus records of the corpus. The log can be in any base if consistently applied.

If the token counts are integer token counts, weight wᵢ is inversely proportional to the ratio of the total number of times token tᵢ appears in the records to the total number of times all tokens appear in the records. If the token counts are binary token counts, weight wᵢ is inversely proportional to the ratio of the number of records in which token tᵢ appears to the total number of records. According to another embodiment, the tokens tᵢ are not weighted to calculate the score.

According to one embodiment, a triangulation technique may be used to identify records that are closely related or even potential duplicates of each other. According to the technique, one or more random point records are selected, where a random point record is a record with random token counts that are designated as a reference frame. Tokens of the records are compared with tokens of the random point records to obtain scores for the records. Records that have at least similar scores for some or all points may be at least closely related or even duplicates of each other. In one example, the origin, where all the token counts are zero, may be used instead of a random point record.

Relationship engine 128 may output the results of the comparison. The output may provide any suitable information. For example, the output may provide the relationship indicator for every record 138. The output may also provide the record identifier or index of any records 138 having a relationship indicator that satisfies a specified threshold such as greater than zero. The output may present the records 138 in order of decreasing or increasing relationship indicators.

Modifications, additions, or omissions may be made to system 100 without departing from the scope of the invention. The modules of system 100 may be integrated or separated according to particular needs. For example, the functions of the modules of system 100 may be provided using a single computer system, for example, a single personal computer. Any of the modules of system 100 may be coupled to another module using one or more networks, a global computer network such as the Internet, or any other appropriate wireline, wireless, or other links.

Moreover, the operations of system 100 may be performed by more, fewer, or other modules. For example, the operations of relationship engine 128 may be performed by more than one module. Additionally, functions may be performed using any suitable logic.

FIG. 2 is an index 250 that may be used to record the token counts of tokens tᵢ of records rᵢ. Index 250 may have any suitable format. According to the illustrated embodiment, index 250 may comprise a token-based index that includes one or more token portions 260. A token portion 260 records different token counts c_{ic} for particular token tᵢ. For example, token tᵢ may have token counts cᵢ₁, cᵢ₂, and cᵢ₃.

Token portion 260 may include one or more rows 264. A row 264 may include a token count portion 268 and a record identifier portion 272. Token count portion 268 of a row 264 specifies a particular token count c_{ic} of token tᵢ. Record identifier portion 272 of the row 264 identifies records rⱼ that have the token count c_{ic} for token tᵢ. For example, rows 264 for token tᵢ may comprise (cᵢ₁, r₁₁, . . . , r₁ₙ), . . . , (cᵢₘ, rₘ₁, . . . , rₘₙ′), where r_{ck} is a record with token count c_{ic} for token tᵢ. According to one embodiment, a token-based index 250 may provide significantly more performance with significantly less memory usage and disk access.

According to another embodiment, index 250 may comprise a record-based index that lists records rⱼ and their token counts c_{ic} for token tᵢ. In one example, a row for record rⱼ may comprise (r₁, c₁₁, . . . , c_{qp}), where cᵢₖ represents the token count of token tᵢ for record rⱼ. In another example, rows for token tᵢ may comprise (r₁, cᵢₗ), . . . , (rₚ, cᵢₚ), where cᵢⱼ represents the token count of token tᵢ for record rⱼ.

Index 250 may use any suitable token counts. According to one embodiment, an integer token count may represent the number of times a particular token tᵢ is in a record rⱼ. According to another embodiment, a binary token count may indicate the presence or absence of a token tᵢ in a record rⱼ. In the embodiment, the token count cᵢⱼ may be either cᵢⱼ=0 to indicate the absence of token tᵢ or cᵢⱼ=1 to indicate the presence of token tᵢ. In one example of a token-based index, rows for token tᵢ may comprise (1, rₘ₁, . . . , rₘₙ′), where the others are assumed to be 0. In one example of a record-based index, a row for record rⱼ may comprise (r₁, 0, 1, . . . , 0). In another example of a record-based index, rows for token tᵢ may comprise (r₁,0), . . . , (rₚ,1), or simply non-zero counts as r₁, . . . , rₙ′.

According to one embodiment, index 250 may include blocks or groups, where each group includes a certain number of records, for example, 50,000 records. A group may be converted independently and stored in a separate file or database records. According to one embodiment, the data of index 250 may be encoded and/or compressed using any suitable technique.

Scores may be computed using any suitable index, for example, a token-based index with integer token counts, a token-based index with binary token counts, a record-based index with integer token counts, a record-based index with binary token counts, other suitable index, or any combination of any of the preceding. Examples of scoring methods that may be used with these indexes are described with reference to FIG. 1.

According to one embodiment, tokens with low information content, or non-discriminating tokens, may be excluded from the search tokens or from search index 250. As an example, the non-discriminating tokens may be dynamically removed from search record when each search is conducted. As another example, the non-discriminating tokens may be removed as the index is being generated. In the example, tokens with unsatisfactory information content may be removed. As another example, the index may include a static list of non-discriminating tokens. In the example, tokens on the list may be excluded from index 250. Removing non-discriminating tokens may speed up processing and/or reduce storage space. For example, removing non-discriminating tokens that appear in more than ⅛ or 1/16 of the records may reduce storage size f by a factor of 6 to 10.

Modifications, additions, or omissions may be made to index 250 without departing from the scope of the invention. Index 250 may include more, fewer, or other portions. Additionally, portions may be arranged in any suitable order.

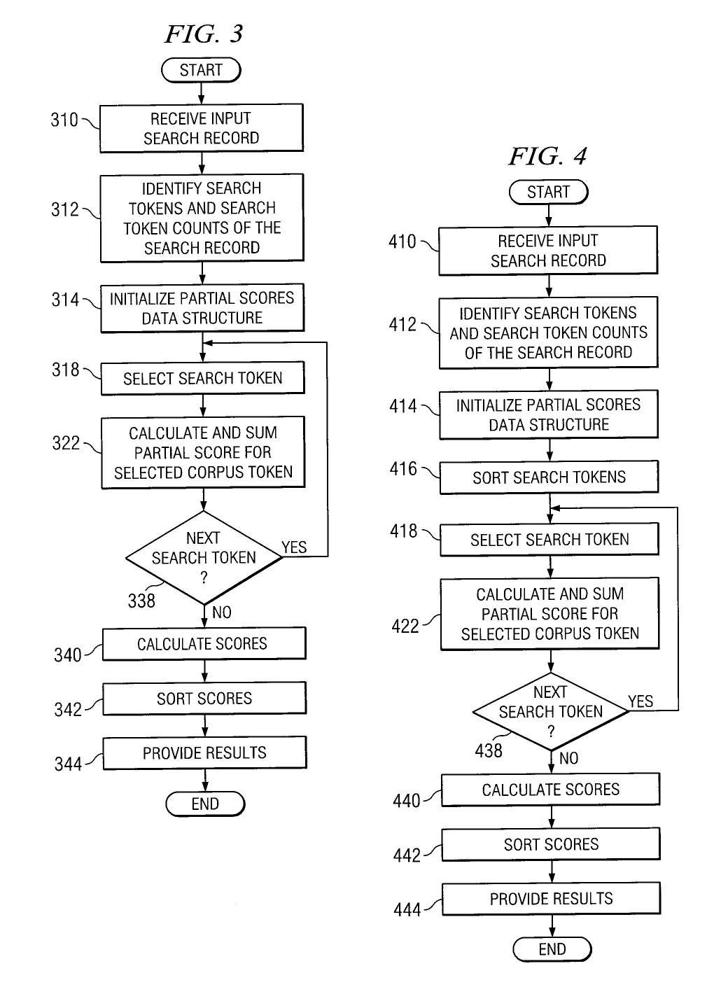

FIG. 3 is a flowchart illustrating one embodiment of a method for identifying relationships among database records that may be used with system 100 of FIG. 1.

The method begins at step 310, where an input search record is received. The search record is to be compared with corpus records of a corpus by comparing tokens of the search record with corresponding tokens of the corpus records. The search tokens and associated search token counts of the search record are identified at step 312. The search tokens and token counts may be identified from token identifiers of the search record. A partial scores data structure representing the record scores is initialized at step 314. The data structure may be initialized by setting the scores of the corpus records to zero or assuming that the scores are zero.

A search token is selected from the search tokens at step 318. The partial scores are calculated and summed for each record that includes the token at step 322. The partial score may be calculated in any suitable manner, such as described with reference to FIG. 1.

If there is a next search token at step 338, the method returns to step 318 to select the next search token. If there is no next search token at step 338, the method proceeds to step 340.

The final scores for the selected corpus records are calculated from the partial scores at step 340. The final scores may be normalized and/or filtered. The score may be calculated in any suitable manner, such as described with reference to FIG. 1.

The scores are sorted at step 342. The scores may be sorted in descending order or ascending order. The results are provided at step 344. The results may include the sorted scores and their corresponding record identifiers. After providing the results, the method ends.

Modifications, additions, or omissions may be made to the method without departing from the scope of the invention. The method may include more, fewer, or other steps. Additionally, steps may be performed in any suitable order without departing from the scope of the invention.

FIG. 4 is a flowchart illustrating another embodiment of a method for identifying relationships among database records that may be used with system 100 of FIG. 1.

The information content of a token is proportional to the ability of the token to distinguish records, and inversely proportional to the amount of data that needs to be read for the token. For example, a high information content may yield a higher weight and a smaller column list. Accordingly, processing higher information tokens before lower information tokens may improve efficiency because higher information tokens have higher discrimination value.

Steps 410 through 416 may be similar to steps 310 through 316 of the method described with reference to FIG. 3. The method begins at step 410, where an input search record is received. The search tokens and associated search token counts of the search record are identified at step 412. A partial scores data structure representing the record scores is initialized at step 414.

The search tokens are sorted from highest information content to lowest information content at step 416. Tokens that fail to satisfy an information content threshold may be removed or ignored. An information content threshold may refer to a threshold at which processing a token may not be worthwhile since the token may fail to add sufficient discriminatory value, that is, the token may be non-discriminating. As an example, a common token appears in many records and thus has little discriminatory value.

An information content threshold may be designated in any suitable manner. In one embodiment, non-discriminating tokens may be defined in terms of an absolute information content value. For example, a token that appears in more than ⅛ or 1/16 of the records may be regarded as non-discriminating. For example, any token that returns more than a predetermined number of records (for example, more than ten million records) may be considered to be non-discriminatory. In another embodiment, non-discriminating tokens may be defined in terms of their information content relative to the information content of other tokens. As an example, tokens with an information content of 10 to 20 bits below the highest information content may be regarded as non-discriminating. As another example, tokens with the lowest percentage of information content may be regarded as non-discriminating.

A search token is selected from the sorted order at step 418. Steps 422 through 442 may be similar to steps 322 through 342 of the method described with reference to FIG. 3. The partial scores are calculated and summed for the selected corpus token at step 422.

If there is a next search token at step 438, the method returns to step 418 to select the next search token. If there is no next search token at step 438, the method proceeds to step 440.

The final scores for the selected corpus records are calculated from the partial scores at step 440. The calculation may involve normalization. The scores are sorted at step 442. The results are provided at step 444. After providing the results, the method ends.

Modifications, additions, or omissions may be made to the method without departing from the scope of the invention. The method may include more, fewer, or other steps. Additionally, steps may be performed in any suitable order without departing from the scope of the invention.

FIG. 5 is a flowchart illustrating one embodiment of a method for identifying relationships among documents that may be used with system 100 of FIG. 1. In the embodiment, a corpus may include corpus records, where a corpus record represents a document. A corpus record may have tokens that represent document parameters and information of the document. The method may be used to identify duplicate documents.

Steps 510 through 516 describe sorting records one or more times to yield groups of potentially similar records. In one embodiment, the records may be sorted using selected similarity metrics to yield groups of potentially similar records. Records within each group may then be sorted to yield groups within the original groups.

In one embodiment, the records may be sorted by parameters to group together records having similar parameters that would suggest similarity. The sorting may be performed in any suitable order. For example, records may be first sorted by coarse parameters and then by fine parameters. Coarse parameters may more quickly sort records, but may not be able to distinguish certain similar records. Fine parameters may be able to distinguish certain similar records, but may not be able to quickly sort records. The number of sorting iterations and the parameters used at each iteration may be selected by a user.

Any suitable scoring technique may be used to sort the records, such as one or more of the scoring techniques described above. Moreover, a particular scoring technique may be used for sorting according to a particular parameter. For example, less time-consuming, yet less precise, scoring technique may be used for a finer parameter.

The method begins at step 510, where the corpus records are sorted to yield groups. According to one embodiment, the corpus records may be sorted according to a coarse parameter, such as effective document size. Effective document size may refer to the count of the characters of the tokens in the document. That is, effective document size may represent the character space size, excluding the white space and non-tokenized characterized characters.

Records within each group are sorted at step 514 to yield groups within the groups. According to one embodiment, the corpus records may be sorted by one or more of any suitable parameters. For example, the records may be sorted by coarser parameters such as the number of tokens, number of pages, the information content of the documents, the total number of tokens, the total number of unique tokens, the scores, and/or other suitable parameter. The records may be constricted by more discriminating tokens such as one-word, two-word, or three-word tokens. Documents with no tokens may also be grouped together.

There may be a next sorting process at step 516. If there is a next sorting process, the method returns to step 514, where the corpus records are sorted. If there is no next sorting process, the method proceeds to step 518.

Potentially duplicate documents are identified according to the sorting at step 518. The sorting groups potentially similar records together, and similar records may indicate potential duplicate documents. After identifying potential duplicate documents, the final near-duplicate scores are determined. The scores may be determined using an asymmetrical differential scoring search restricted to nearby sorted documents. The method then ends.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that tokens of the search record are compared with corresponding tokens of corpus records to identify relationships between the search record and the corpus records. Comparing by iterating over tokens may be more efficient than comparing by iterating over records.

A technical advantage of another embodiment may be that a token-based index may be used to describe the corpus records. The index may include token portions that identify corpus records that have a particular token count. The index may provide for more efficient retrieval of information about the corpus.

A technical advantage of another embodiment may be that a symmetrical differential scoring formula may be used to distinguish corpus records that are different from (either larger or smaller than) a search record from corpus records that are at least approximately equivalent to the search record.

A technical advantage of another embodiment may be that corpus tokens may be filtered according to information content. In one example, corpus tokens may be processed from higher information content tokens to lower information content tokens, which may allow for more efficient analysis. In another example, corpus tokens that fail to satisfy an information content threshold may be removed, which may allow for more efficient analysis.

A technical advantage of another embodiment may be that corpus records may represent documents. The corpus records may be compared to identify duplicate or near-duplicate documents.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for identifying one or more relationships among a plurality of records, comprising:
accessing a search record comprising a plurality of search tokens, a search token associated with a search token count;
accessing a plurality of corpus records, a corpus record comprising a plurality of corpus tokens, a corpus token associated with a corpus token count;
repeating the following for each search token of at least a subset of the plurality of search tokens:
identifying one or more corpus tokens corresponding to the each search token; and
comparing the each search token with the one or more corresponding corpus tokens to yield one or more comparisons; and
determining a relationship between the search record and at least one corpus record in accordance with the one or more comparisons.

2. The method of claim 1, wherein comparing the each search token with the one or more corresponding corpus tokens further comprises performing one of:
comparing the each search token with the corresponding corpus tokens according to a symmetrical differential scoring formula; or
comparing each search token with the corresponding corpus tokens according to an asymmetrical subset scoring formula.

3. The method of claim 1, further comprising:
establishing a weight for each corresponding corpus token of the one or more corresponding corpus tokens to yield one or more weights, the weight reflecting an information content of the each corresponding corpus token; and
calculating one or more partial scores for the one or more corresponding corpus tokens using the one or more weights.

4. The method of claim 1, wherein comparing the each search token with the one or more corresponding corpus tokens further comprises:
comparing the search token count of the each search token with the one or more corpus token counts of the one or more corresponding corpus tokens.

5. The method of claim 4, wherein the search token count and the corpus token count each comprise one of:
an integer value; or
a binary value.

6. The method of claim 1, wherein comparing the each search token with the one or more corresponding corpus tokens further comprises:
filtering the one or more corresponding corpus tokens according to information content of the one or more corresponding corpus tokens.

7. The method of claim 1, further comprising:
accessing a token-based index, the token-based index identifying one or more corpus records having a particular token count for a particular corpus token.

8. The method of claim 7, wherein each particular token count comprises one of:
an integer value; or
a binary value.

9. A system for identifying one or more relationships among a plurality of records, comprising:
a memory operable to:
store a plurality of corpus records, a corpus record comprising a plurality of corpus tokens, a corpus token associated with a corpus token count; and
a processor coupled to the memory and operable to:
access a search record comprising a plurality of search tokens, a search token associated with a search token count;
repeat the following for each search token of at least a subset of the plurality of search tokens:
identify one or more corpus tokens corresponding to the each search token; and
compare the each search token with the one or more corresponding corpus tokens to yield one or more comparisons; and
determine a relationship between the search record and at least one corpus record in accordance with the one or more comparisons.

10. The system of claim 9, the processor further operable to compare the each search token with the one or more corresponding corpus tokens by performing one of:
comparing the each search token with the corresponding corpus tokens according to a symmetrical differential scoring formula; or
comparing each search token with the corresponding corpus tokens according to an asymmetrical subset scoring formula.

11. The system of claim 9, the processor further operable to:
establish a weight for each corresponding corpus token of the one or more corresponding corpus tokens to yield one or more weights, the weight reflecting an information content of the each corresponding corpus token; and
calculate one or more partial scores for the one or more corresponding corpus tokens using the one or more weights.

12. The system of claim 9, the processor further operable to compare the each search token with the one or more corresponding corpus tokens by:
comparing the search token count of the each search token with the one or more corpus token counts of the one or more corresponding corpus tokens.

13. The system of claim 12, wherein the search token count and the corpus token count each comprise one of:
an integer value; or
a binary value.

14. The system of claim 9, the processor further operable to compare the each search token with the one or more corresponding corpus tokens by:
filtering the one or more corresponding corpus tokens according to information content of the one or more corresponding corpus tokens.

15. The system of claim 9, the processor further operable to:
access a token-based index, the token-based index identifying one or more corpus records having a particular token count for a particular corpus token.

16. The system of claim 15, wherein each particular token count comprises one of:
an integer value; or
a binary value.

17. Logic for identifying one or more relationships among a plurality of records, the logic encoded in a computer-readable storage media and operable to:
access a search record comprising a plurality of search tokens, a search token associated with a search token count;
access a plurality of corpus records, a corpus record comprising a plurality of corpus tokens, a corpus token associated with a corpus token count;
repeat the following for each search token of at least a subset of the plurality of search tokens:
identify one or more corpus tokens corresponding to the each search token; and
compare the each search token with the one or more corresponding corpus tokens to yield one or more comparisons; and
determine a relationship between the search record and at least one corpus record in accordance with the one or more comparisons.

18. The logic of claim 17, further operable to compare the each search token with the one or more corresponding corpus tokens by performing one of:
comparing the each search token with the corresponding corpus tokens according to a symmetrical differential scoring formula; or
comparing each search token with the corresponding corpus tokens according to an asymmetrical subset scoring formula.

19. The logic of claim 17, further operable to:
establish a weight for each corresponding corpus token of the one or more corresponding corpus tokens to yield one or more weights, the weight reflecting an information content of the each corresponding corpus token; and
calculate one or more partial scores for the one or more corresponding corpus tokens using the one or more weights.

20. The logic of claim 17, further operable to compare the each search token with the one or more corresponding corpus tokens by:
comparing the search token count of the each search token with the one or more corpus token counts of the one or more corresponding corpus tokens.

21. The logic of claim 20, wherein the search token count and the corpus token count each comprise one of:
an integer value; or
a binary value.

22. The logic of claim 17, further operable to compare the each search token with the one or more corresponding corpus tokens by:
filtering the one or more corresponding corpus tokens according to information content of the one or more corresponding corpus tokens.

23. The logic of claim 17, further operable to:
access a token-based index, the token-based index identifying one or more corpus records having a particular token count for a particular corpus token.

24. The logic of claim 23, wherein each particular token count comprises one of:
an integer value; or
a binary value.

25. A system for identifying one or more relationships among a plurality of records, comprising:
means for accessing a search record comprising a plurality of search tokens, a search token associated with a search token count;
means for accessing a plurality of corpus records, a corpus record comprising a plurality of corpus tokens, a corpus token associated with a corpus token count;
means for repeating the following for each search token of at least a subset of the plurality of search tokens:
identifying one or more corpus tokens corresponding to the each search token; and
comparing the each search token with the one or more corresponding corpus tokens to yield one or more comparisons; and
means for determining a relationship between the search record and at least one corpus record in accordance with the one or more comparisons.

26. A method for identifying one or more relationships among a plurality of records, comprising:
accessing a search record comprising a plurality of search tokens, a search token associated with a search token count;
accessing a plurality of corpus records, a corpus record comprising a plurality of corpus tokens, a corpus token associated with a corpus token count, the search token count and the corpus token count each comprising one of:
an integer value; or
a binary value;
accessing a token-based index, the token-based index identifying one or more corpus records having a particular token count for a particular corpus token, each particular token count comprising one of:
an integer value; or
a binary value;
repeating the following for each search token of at least a subset of the plurality of search tokens:
identifying one or more corpus tokens corresponding to the each search token; and
comparing the each search token with the one or more corresponding corpus tokens to yield one or more comparisons by:
performing one of:
comparing the each search token with the corresponding corpus tokens according to a symmetrical differential scoring formula; or
comparing each search token with the corresponding corpus tokens according to an asymmetrical subset scoring formula;
comparing the search token count of the each search token with the one or more corpus token counts of the one or more corresponding corpus tokens; and
filtering the one or more corresponding corpus tokens according to information content of the one or more corresponding corpus tokens;
determining a relationship between the search record and at least one corpus record in accordance with the one or more comparisons;
establishing a weight for each corresponding corpus token of the one or more corresponding corpus tokens to yield one or more weights, the weight reflecting an information content of the each corresponding corpus token; and
calculating one or more partial scores for the one or more corresponding corpus tokens using the one or more weights.

27. A method for identifying one or more relationships among a plurality of records, comprising:
accessing a search record comprising a plurality of search tokens, a search token associated with a search token count;
accessing a plurality of corpus records, a corpus record comprising a plurality of corpus tokens, a corpus token associated with a corpus token count;
filtering the plurality of corpus tokens according to information content of the plurality of corpus tokens to yield one or more discriminating tokens; and
determining a relationship between the search record and at least one corpus record according to the one or more discriminating tokens.

28. The method of claim 27, wherein filtering the plurality of corpus tokens according to information content of the plurality of corpus tokens to yield the one or more discriminating tokens further comprises:
identifying one or more corpus tokens each corresponding to a search token of the plurality of search tokens; and
determining the one or more discriminating tokens from the one or more identified corpus tokens according to the information content of the one or more identified corpus tokens.

29. The method of claim 27, wherein filtering the plurality of corpus tokens according to information content of the plurality of corpus tokens to yield the one or more discriminating tokens further comprises:
identifying one or more corpus tokens each corresponding to a search token of the plurality of search tokens;
sorting the one or more identified corpus tokens according to the information content of the one or more identified corpus tokens to yield a token order from a higher information content to a lower information content; and
comparing at least a subset of the one or more identified corpus tokens to the corresponding search token in the token order.

30. The method of claim 27, wherein filtering the plurality of corpus tokens according to information content of the plurality of corpus tokens to yield the one or more discriminating tokens further comprises:
determining the one or more discriminating tokens according to a plurality of predetermined discriminating tokens.

31. The method of claim 27, wherein filtering the plurality of corpus tokens according to information content of the plurality of corpus tokens to yield the one or more discriminating tokens further comprises:
determining the one or more discriminating tokens according to an information content threshold.

32. The method of claim 27, wherein filtering the plurality of corpus tokens according to information content of the plurality of corpus tokens to yield the one or more discriminating tokens further comprises:
removing one or more non-discriminating tokens from an index of the plurality of corpus records.

33. The method of claim 27, wherein filtering the plurality of corpus tokens according to information content of the plurality of corpus tokens to yield the one or more discriminating tokens further comprises:
removing one or more non-discriminating tokens from the plurality of search tokens.

34. The method of claim 27, wherein filtering the plurality of corpus tokens according to information content of the plurality of corpus tokens to yield the one or more discriminating tokens further comprises:
excluding one or more non-discriminating tokens from an index of the plurality of corpus records.

35. A system for identifying one or more relationships among a plurality of records, comprising:
a memory operable to:
store a plurality of corpus records, a corpus record comprising a plurality of corpus tokens, a corpus token associated with a corpus token count; and
a processor coupled to the memory and operable to:
access a search record comprising a plurality of search tokens, a search token associated with a search token count;
filter the plurality of corpus tokens according to information content of the plurality of corpus tokens to yield one or more discriminating tokens; and
determine a relationship between the search record and at least one corpus record according to the one or more discriminating tokens.

36. The system of claim 35, the processor further operable to filter the plurality of corpus tokens according to information content of the plurality of corpus tokens to yield the one or more discriminating tokens by:
identifying one or more corpus tokens each corresponding to a search token of the plurality of search tokens; and
determining the one or more discriminating tokens from the one or more identified corpus tokens according to the information content of the one or more identified corpus tokens.

37. The system of claim 35, the processor further operable to filter the plurality of corpus tokens according to information content of the plurality of corpus tokens to yield the one or more discriminating tokens by:
identifying one or more corpus tokens each corresponding to a search token of the plurality of search tokens;
sorting the one or more identified corpus tokens according to the information content of the one or more identified corpus tokens to yield a token order from a higher information content to a lower information content; and
comparing at least a subset of the one or more identified corpus tokens to the corresponding search token in the token order.

38. The system of claim 35, the processor further operable to filter the plurality of corpus tokens according to information content of the plurality of corpus tokens to yield the one or more discriminating tokens by:
determining the one or more discriminating tokens according to a plurality of predetermined discriminating tokens.

39. The system of claim 35, the processor further operable to filter the plurality of corpus tokens according to information content of the plurality of corpus tokens to yield the one or more discriminating tokens by:
determining the one or more discriminating tokens according to an information content threshold.

40. The system of claim 35, the processor further operable to filter the plurality of corpus tokens according to information content of the plurality of corpus tokens to yield the one or more discriminating tokens by:
removing one or more non-discriminating tokens from an index of the plurality of corpus records.

41. The system of claim 35, the processor further operable to filter the plurality of corpus tokens according to information content of the plurality of corpus tokens to yield the one or more discriminating tokens by:
removing one or more non-discriminating tokens from the plurality of search tokens.

42. The system of claim 35, the processor further operable to filter the plurality of corpus tokens according to information content of the plurality of corpus tokens to yield the one or more discriminating tokens by:
excluding one or more non-discriminating tokens from an index of the plurality of corpus records.

43. Logic for identifying one or more relationships among a plurality of records, the logic encoded in a computer-readable storage media and operable to:
access a search record comprising a plurality of search tokens, a search token associated with a search token count;
access a plurality of corpus records, a corpus record comprising a plurality of corpus tokens, a corpus token associated with a corpus token count;
filter the plurality of corpus tokens according to information content of the plurality of corpus tokens to yield one or more discriminating tokens; and
determine a relationship between the search record and at least one corpus record according to the one or more discriminating tokens.

44. The logic of claim 43, further operable to filter the plurality of corpus tokens according to information content of the plurality of corpus tokens to yield the one or more discriminating tokens by:
identifying one or more corpus tokens each corresponding to a search token of the plurality of search tokens; and
determining the one or more discriminating tokens from the one or more identified corpus tokens according to the information content of the one or more identified corpus tokens.

45. The logic of claim 43, further operable to filter the plurality of corpus tokens according to information content of the plurality of corpus tokens to yield the one or more discriminating tokens by:
identifying one or more corpus tokens each corresponding to a search token of the plurality of search tokens;
sorting the one or more identified corpus tokens according to the information content of the one or more identified corpus tokens to yield a token order from a higher information content to a lower information content; and
comparing at least a subset of the one or more identified corpus tokens to the corresponding search token in the token order.

46. The logic of claim 43, further operable to filter the plurality of corpus tokens according to information content of the plurality of corpus tokens to yield the one or more discriminating tokens by:
determining the one or more discriminating tokens according to a plurality of predetermined discriminating tokens.

47. The logic of claim 43, further operable to filter the plurality of corpus tokens according to information content of the plurality of corpus tokens to yield the one or more discriminating tokens by:
determining the one or more discriminating tokens according to an information content threshold.

48. The logic of claim 43, further operable to filter the plurality of corpus tokens according to information content of the plurality of corpus tokens to yield the one or more discriminating tokens by:
removing one or more non-discriminating tokens from an index of the plurality of corpus records.

49. The logic of claim 43, further operable to filter the plurality of corpus tokens according to information content of the plurality of corpus tokens to yield the one or more discriminating tokens by:
removing one or more non-discriminating tokens from the plurality of search tokens.

50. The logic of claim 43, further operable to filter the plurality of corpus tokens according to information content of the plurality of corpus tokens to yield the one or more discriminating tokens by:
excluding one or more non-discriminating tokens from an index of the plurality of corpus records.

51. A system for identifying one or more relationships among a plurality of records, comprising:
means for accessing a search record comprising a plurality of search tokens, a search token associated with a search token count;
means for accessing a plurality of corpus records, a corpus record comprising a plurality of corpus tokens, a corpus token associated with a corpus token count;
means for filtering the plurality of corpus tokens according to information content of the plurality of corpus tokens to yield one or more discriminating tokens; and
means for determining a relationship between the search record and at least one corpus record according to the one or more discriminating tokens.

52. A method for identifying one or more relationships among a plurality of records, comprising:
accessing a search record comprising a plurality of search tokens, a search token associated with a search token count;
accessing a plurality of corpus records, a corpus record comprising a plurality of corpus tokens, a corpus token associated with a corpus token count;
filtering the plurality of corpus tokens according to information content of the plurality of corpus tokens to yield one or more discriminating tokens by:
identifying one or more corpus tokens each corresponding to a search token of the plurality of search tokens;
determining a first portion of the one or more discriminating tokens from the one or more identified corpus tokens according to the information content of the one or more identified corpus tokens;
sorting the one or more identified corpus tokens according to the information content of the one or more identified corpus tokens to yield a token order from a higher information content to a lower information content;
comparing at least a subset of the one or more identified corpus tokens to the corresponding search token in the token order;
determining a second portion of the one or more discriminating tokens according to a plurality of predetermined discriminating tokens;
determining a third portion of the one or more discriminating tokens according to an information content threshold;
removing one or more non-discriminating tokens from an index of the plurality of corpus records;
removing the one or more non-discriminating tokens from the plurality of search tokens; and
excluding the one or more non-discriminating tokens from an index of the plurality of corpus records; and
determining a relationship between the search record and at least one corpus record according to the one or more discriminating tokens.

53. A method for identifying one or more relationships among a plurality of records, comprising:
accessing a search record comprising a plurality of search tokens, a search token associated with a search token count;
accessing a plurality of corpus records, a corpus record comprising a plurality of corpus tokens, a corpus token associated with a corpus token count;
comparing the plurality of search tokens with at least a subset the plurality of corpus tokens; and
calculating a score operable to distinguish a first corpus record that is a subset of the search record from a second corpus record that is approximately equivalent to the search record.

54. The method of claim 53, wherein calculating the score further comprises:
calculating the score according to a symmetrical differential scoring formula.

55. A system for identifying one or more relationships among a plurality of records, comprising:
a memory operable to:
store a plurality of corpus records, a corpus record comprising a plurality of corpus tokens, a corpus token associated with a corpus token count; and
a processor coupled to the memory and operable to:
access a search record comprising a plurality of search tokens, a search token associated with a search token count;
compare the plurality of search tokens with at least a subset the plurality of corpus tokens; and
calculate a score operable to distinguish a first corpus record that is a subset of the search record from a second corpus record that is approximately equivalent to the search record.

56. The system of claim 55, the processor further operable to calculate the score by:
calculating the score according to a symmetrical differential scoring formula.

57. Logic for identifying one or more relationships among a plurality of records, the logic encoded in a computer-readable storage media and operable to:
access a search record comprising a plurality of search tokens, a search token associated with a search token count;
access a plurality of corpus records, a corpus record comprising a plurality of corpus tokens, a corpus token associated with a corpus token count;
compare the plurality of search tokens with at least a subset the plurality of corpus tokens; and
calculate a score operable to distinguish a first corpus record that is a subset of the search record from a second corpus record that is approximately equivalent to the search record.

58. The logic of claim 57, further operable to calculate the score by:
calculating the score according to a symmetrical differential scoring formula.

59. A system for identifying one or more relationships among a plurality of records, comprising:
means for accessing a search record comprising a plurality of search tokens, a search token associated with a search token count;
means for accessing a plurality of corpus records, a corpus record comprising a plurality of corpus tokens, a corpus token associated with a corpus token count;
means for comparing the plurality of search tokens with at least a subset the plurality of corpus tokens; and
means for calculating a score operable to distinguish a first corpus record that is a subset of the search record from a second corpus record that is approximately equivalent to the search record.

60. A method for identifying one or more relationships among a plurality of records, comprising:
accessing a search record comprising a plurality of search tokens, a search token associated with a search token count;
accessing a plurality of corpus records, a corpus record comprising a plurality of corpus tokens, a corpus token associated with a corpus token count;
comparing the plurality of search tokens with at least a subset the plurality of corpus tokens; and
calculating a score operable to distinguish a first corpus record that is a subset of the search record from a second corpus record that is approximately equivalent to the search record, by:
calculating the score according to a symmetrical differential scoring formula.

61. A method for identifying one or more relationships among a plurality of records, comprising:
accessing a plurality of corpus records, a corpus record comprising a plurality of corpus tokens;
repeating the following for one or more iterations to yield one or more final groups:
sorting a current group of corpus records to yield a plurality of next groups by performing the following for each corpus record of at least a subset of the current group:
designating the each corpus record as a search record comprising a plurality of search tokens; and
comparing the plurality of search tokens with the plurality of corresponding corpus tokens of each of the other corpus records, the comparisons indicating a degree of similarity between the search record and the each of the other corpus records; and
forming the plurality of next groups in accordance with the comparisons; and
identifying at least similar corpus records according the one or more final groups.

62. The method of claim 61, further comprising:
sorting the plurality of corpus records according to document size.

63. The method of claim 61, wherein a search token of the plurality of search tokens comprises:
an ordered set of a plurality of words.

64. A system for identifying one or more relationships among a plurality of records, comprising:
a memory operable to:
store a plurality of corpus records, a corpus record comprising a plurality of corpus tokens; and
a processor coupled to the memory and operable to:
repeat the following for one or more iterations to yield one or more final groups:
sort a current group of corpus records to yield a plurality of next groups by performing the following for each corpus record of at least a subset of the current group:
designate the each corpus record as a search record comprising a plurality of search tokens; and
compare the plurality of search tokens with the plurality of corresponding corpus tokens of each of the other corpus records, the comparisons indicating a degree of similarity between the search record and the each of the other corpus records; and
form the plurality of next groups in accordance with the comparisons; and
identify at least similar corpus records according the one or more final groups.

65. The system of claim 64, the processor further operable to:
sort the plurality of corpus records according to document size.

66. The system of claim 64, wherein a search token of the plurality of search tokens comprises:
an ordered set of a plurality of words.

67. Logic for identifying one or more relationships among a plurality of records, the logic encoded in a computer-readable storage media and operable to:
access a plurality of corpus records, a corpus record comprising a plurality of corpus tokens;
repeat the following for one or more iterations to yield one or more final groups:
sort a current group of corpus records to yield a plurality of next groups by performing the following for each corpus record of at least a subset of the current group:
designate the each corpus record as a search record comprising a plurality of search tokens; and
compare the plurality of search tokens with the plurality of corresponding corpus tokens of each of the other corpus records, the comparisons indicating a degree of similarity between the search record and the each of the other corpus records; and
form the plurality of next groups in accordance with the comparisons; and
identify at least similar corpus records according the one or more final groups.

68. The logic of claim 67, further operable to:
sort the plurality of corpus records according to document size.

69. The logic of claim 67, wherein a search token of the plurality of search tokens comprises:
an ordered set of a plurality of words.

70. A system for identifying one or more relationships among a plurality of records, comprising:
means for accessing a plurality of corpus records, a corpus record comprising a plurality of corpus tokens;
means for repeating the following for one or more iterations to yield one or more final groups:
sorting a current group of corpus records to yield a plurality of next groups by performing the following for each corpus record of at least a subset of the current group:
designating the each corpus record as a search record comprising a plurality of search tokens; and
comparing the plurality of search tokens with the plurality of corresponding corpus tokens of each of the other corpus records, the comparisons indicating a degree of similarity between the search record and the each of the other corpus records; and
forming the plurality of next groups in accordance with the comparisons; and
means for identifying at least similar corpus records according the one or more final groups.

71. A method for identifying one or more relationships among a plurality of records, comprising:
accessing a plurality of corpus records, a corpus record comprising a plurality of corpus tokens;
repeating the following for one or more iterations to yield one or more final groups:
sorting a current group of corpus records to yield a plurality of next groups by performing the following for each corpus record of at least a subset of the current group:
designating the each corpus record as a search record comprising a plurality of search tokens, a search token of the plurality of search tokens comprising an ordered set of a plurality of words; and
comparing the plurality of search tokens with the plurality of corresponding corpus tokens of each of the other corpus records, the comparisons indicating a degree of similarity between the search record and the each of the other corpus records; and
forming the plurality of next groups in accordance with the comparisons;
identifying at least similar corpus records according the one or more final groups; and
sorting the plurality of corpus records according to document size.
